(19) United States
(12) Patent Application Publication
(10) Pub. No.: US 2011/0280994 A1
(43) Pub. Date: Nov. 17, 2011

(54) Tortilla Seasoning Applicator and Method of Use Thereof

(76) Inventors: Dametrus Abduel Redd, Memphis, TN (US); Sharrliyn Matthews, Memphis, TN (US)

(21) Appl. No.: 12/781,647

(22) Filed: May 17, 2010

(51) Int. Cl. A23L 1/00

(52) U.S. Cl. 426/89

(57) ABSTRACT

A novel enclosed manual seasoning applicator including two concentric sieved internal components positioned on either side of a subject tortilla is provided. Such a device permits a user to apply any level of desired seasonings to a flat tortilla (or other like flat food product) without spilling or wasting any of the powdered and/or granulated seasoning product itself. The novel device includes a two similarly shaped portions that releasable attach together after introduction of seasoning materials in either or both portions, each portion having a sieve portion as well for the selected delivery of seasoning to an inserted tortilla after both portions are attached and operated through manual movement to permit passage of the seasoning material through each sieve onto the subject tortilla surface. As such, the inventive device, allows for proper and thorough coating of the subject tortilla in such a manner without egress of seasoning outside the device, permitting, as well, a portable tortilla applicator that is easy to use and clean. A method of utilizing such a unique, self-contained individual tortilla coating device is encompassed within this invention also.

### FIELD OF THE INVENTION

A novel enclosed manual seasoning applicator including two concentric sieved internal components positioned on either side of a subject flat food product (e.g., a tortilla) is provided. Such a device permits a user to apply any level of desired seasonings to a flat tortilla (or other like food product) without spilling or wasting any of the powdered and/or granulated seasoning product itself. The novel device includes a two similarly shaped portions that releasable attach together after introduction of seasoning materials in either or both portions, each portion having a sieve portion as well for the selected delivery of seasoning to an inserted tortilla after both portions are attached and operated through manual movement to permit passage of the seasoning material through each sieve onto the subject tortilla surface. As such, the inventive device allows for proper and thorough coating of the subject tortilla in such a manner without egress of seasoning outside the device, providing, as well, an effective portable tortilla applicator that is easy to use and clean. A method of utilizing such a unique, self-contained individual tortilla coating device is encompassed within this invention also.

### BACKGROUND OF THE INVENTION

Personal tastes, particularly in terms of food products, dictate, at times, the availability of different selections for consumption in terms of seasoned items. For instance, a consumer may wish to partake of a heavily spiced foodstuff on one day, while the next desire the flavor of a sweetened comestible. In such situations, the consumer may express the desire to ingest the same type of food product, albeit with totally different flavorings present throughout or thereon. Unfortunately, the prepared food industry generally provides supplies of foodstuffs in bulk, having the same consistency and flavor, in order to simplify product offerings to the public; were the food preparer to supply individually offered food products with different seasonings/flavoring applied, the costs for such a possibility would be rather high, thereby rendering, for all intents and purposes, the ability to sell such products prohibitive.

Although certain food industries do provide individual selections with some items (for instance, the confectionary industry supplies individual candy bars, and the soft drink industry supplies individual beverages, both in terms of different types and, at times, flavors), there are large portions of the prepared food industry that do not provide such specific product offerings. Notably, the ever growing tortilla-based sector in this broad industry generally provides different selections of products based upon carbohydrate sources; thus, tortillas that are made from cornmeal, wheat, and flour (as well as other similar sources) dominate the landscape. Such different products offer the consumer choices in terms of nutritional content, certainly, and, in some situations, such bulk offerings are made with the packaged multiple tortillas flavored in some fashion, but all alike. The choice for a consumer to select different flavors at different times generally requires the purchase of multiple bulk packages of such tortilla products, thereby risking the degradation and/or spoiling of the food products over time (that is, without possibly ingesting all of the multiple tortillas in a short time, or freezing the packages, thereby potentially damaging the nutritional value and constitution as well).

As noted above, individually flavored tortilla selections are atypical for mass consumption within the prepared foodstuff industry. Such tortilla products may be utilized to prepare any number of culinary dishes, including, without limitation, foods that are considered, popularly, Mexican, Central American, and South American in nature. Soft tortillas (those that have not been fried to a crisp consistency) may be manipulated and folded to produce tacos, enchiladas, burritos, flautas, basically any standard accepted concoction including a tortilla base and further ingredients (such as meat, vegetables, salsas, cheeses, and the like). Hard tortillas (those that have been made crisp) may be utilized in a flat shape as a layer of a different type of food product, or the base for layering of different types of ingredients, such as those noted above. The permutations of different ways of using such tortillas and selected ingredients therewith are plentiful. The availability, however, of bulk products including seasonings and/or flavoring present within such tortillas and/or on the surfaces thereof, is lacking. Thus, to placate consumers with further choices in flavors and tastes with such flat food products (other flat products may include breads, pitas, crackers, pancakes, and the like), there exists a need to provide, if not in bulk form such product offerings, but the possibility for individual consumers to apply their own types of flavors and seasonings to such items.

As noted above, bulk offerings of uniformly flavored food products do exist. Such foods are typically flavored and/or seasoned in large-scale apparatuses that include sieves (or filters) for the selected transfer and separation into small particulates and/or powders and/or granulates of such types of additives. For instance, typical tortilla chip manufacturing methods include cornmeal production, separation of individual masses of meal into flattened shapes, deep frying (or baking, in certain situations) of the flattened meal, and then cooling and packaging. If specific flavors are desired, such could be administered within the cornmeal formulation at the outset, or applied through a sieving device over the cornmeal prior to frying or baking, or, alternatively, subsequent to the heating step (particularly if the flavoring application is specifically for the surface and the coating is not limited to one that will not typically discolor or transfer to a consumer's fingers and/or mouth during ingestion). Such a standard method, however, provides multiple finished products in bulk form, limiting the selection for the consumer to the purchase of a plethora of flavored items.

Furthermore, such a system is typically not provided in a manner that prevents introduction of the powdered, particulate, and/or granulated flavoring and/or seasoning outside of the application vessel. Such large-scale procedures may recapture unused powders, etc., that do not coat the subject foodstuffs; however, as well, such powders, etc., may enter the environment and coat or stain or otherwise undesirably contact a person's clothes, the utilized machinery, or any other material or device in the surrounding area. In essence, such a large-scale process does not take into consideration an individual foodstuff application, nor does it permit such a small-scale method coupled with low degrees of possible contamination of localized environments.

Thus, although there do exist manners of applying powdered, granulated, particulate, etc., seasonings and/or flavoring to foodstuffs, the consideration of small-scale devices for such individualized and selective end results as noted above are not currently available, particularly for substantially flat food products, and certainly not for flat tortilla products. As such, the present invention provides a new manner of coating such a substantially flat foodstuff for a consumer to apply any desired type of flavoring, as well as any amount thereof, to such a food product.

### ADVANTAGES AND SUMMARY OF THE INVENTION

An advantage of the inventive flavoring/seasoning device is the ability to transfer selected amounts of solid materials to a flat-surfaced foodstuff without fear of contamination or spillage of such materials outside of the device. Another advantage of such a device is the ability to apply a coating of a powdered, granulated, and/or particulate flavoring and/or seasoning to a flat food product prior to further heating for integral introduction of the flavoring and/or seasoning into the food product itself. Yet another advantage of the inventive application device is the reliability in thoroughly and evenly coating the targeted flat food product with the desired flavoring and/or seasoning on an individual basis, as well as the ability to easily and quickly clean the device for the purpose of applying a different flavor and/or seasoning to a subsequent food product or to apply a further coating to the same food product.

Accordingly, this invention encompasses a manually operated and fully enclosed device for the application of a powdered or granulated substance to a flat food product, said device including at least two bowl portions (preferably, though not necessarily, substantially circular in shape) and two sieve components shaped to fit within said at least two bowl portions (and thus said sieve components are preferably, though not necessarily, substantially circular as well) such that upon attachment of said bowl portions and inclusion and attachment of said sieve components within said bowl portions, each resultant bowl portion exhibits a hollow region for the presence of a powdered or granulated substance, wherein said bowl portions and said sieve components, when attached together, form an integrated, yet detachable, enclosure, and wherein said sieve portions are positioned internally within said connected bowl portions to allow for the placement of said flat food product between said sieve components such that said powdered or granulated substance may pass through said sieve components to contact at least a portion of said flat food product. Also encompassed within this invention is a method of applying a powdered or granulated substance to at least one flat food product, said method comprising supplying the device as described above, wherein said bowl portions have not been attached to one another; introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions; placing said sieve components over said materials in nesting fashion within each of said bowl portions; placing said at least one flat food product onto the surface of one of said sieve components such that said food product is parallel to said sieve component surface; attaching said bowl portions together through said locking mechanism to form the fully enclosed device; and manually moving said fully enclosed device to permit movement of said materials through said sieve components to contact the surface of said at least one flat food product.

Preferably, said device is made entirely from a polymeric (plastic) source, although any resilient material that may withstand repeated use in such a manner may be utilized for such a purpose as well. As such, plastic (such as polyacetal, polystyrene, polycarbonate, high density polyethylene, and any other resilient polymer), rubber (including vulcanized rubber), may constitute the any component, including the aforementioned circular portions and the sieving components. Metal, such as aluminum, steel, brass, and the like, may constitute any portion of the device as well. The sieving components may, for one example, be aluminum mesh structures to permit passage of the powdered, etc., flavoring and/or seasoning from the hollow areas of the circular portions to the targeted flat food product. Also, the materials from which such component parts are made are preferably dishwasher-safe in nature to facilitate cleaning of the entirety of the device in such a manner.

Preferably, the bowl portions are circular in shape and are sufficiently sized in diameter to accept typically sized tortilla food stuffs. Thus, the diameter should be roughly 10 to 15 inches (from 25.4 to 38.1 centimeters). One portion may be slightly larger than the other to allow for overlapping attachment of the peripheral edges of one portion by the other. Thus, a slight difference in overall diameter by about from 0.001 inches to 0.2 inches (roughly 0.2 to 0.5 millimeters) is potentially preferred. In such a configuration, a lip may be introduced within the inner diameter portion that clips within an overlapping periphery to permit stable attachment of the two portions together, but also the ability to easily detach the two portions from each other if and when desired. Such detachability facilitates both cleaning of the entire device when desired as well as the entire enclosure of the coating mechanism during utilization. Preferably, though not necessarily, the bowl portions are manufactured from resilient plastic, such as high density polyethylene, due to cost and performance reasons. The portions may be molded in any manner to provide the necessary bowl configurations, as well, to permit the hollow areas within each portion. The term “bowl” is intended to indicate any open-ended vessel that may hold any product when placed on a flat surface with the open end facing upwards; any geometric shape, including circular, triangular, square, trapezoidal, rhombus, and the like, may be utilized in this manner as long as the two bowl portions are attachable to form a fully enclosed device and the sieve components fit snugly within the internal areas of the enclosed device during use; a circular shape for the bowl portions is preferred, as noted previously. The hollow areas within the fully enclosed device are utilized for the storage of the powdered, etc., flavoring and/or seasoning prior to, during, and after application to the targeted substantially flat food product. If desired, too, indentations within one or both of the bowl portions may be present to facilitate handling of the device during operation, or, additionally, for the placement of the sieving component or components for the purpose of placing such components at specific regions within the circular portions during utilization. Such indentations may be of any configuration and number, although two similarly shaped, parallel indentations of roughly 3 inches length (7.62 centimeters) and ½ inch width and depth (roughly 1.27 centimeters). Again, though, any number of indentations, including zero, as well as any configuration of such indentations, including further circular shapes, as a non-limiting example, may be present if desired.

Another potential addition to the bowl portions of the inventive device is at least one opening, either in movable panel, hinged door, or removable insert, within the outer periphery of either or both portions. Such an opening facilitates introduction of the powdered, granulated, and/or particulate flavoring and/or seasoning within the hollow areas of the device (when the sieving components are in place internally). One opening may be situated at any location on the periphery of either circular portion and may be the only such opening present within the entire device. Alternatively, no such opening may be present or multiple openings may be present over one or both circular portions. The important issue with regard to such an opening is that one may be present if the manufacturer so desires for the purposes noted above. Such an opening may, as well, facilitate removal of the powdered, etc., flavoring and/or seasoning by pouring such materials out of the device after use. Additionally, the retention of the attachment between the two circular portions may continue and the opening may facilitate cleaning through introduction of water, cleaning fluid, etc., therein, if desired. Generally, however, cleaning would be accomplished through complete detachment and disassembly of the entire device followed by individual cleaning of the component parts.

The term “sieving components” is intended to encompass a properly shaped filtering article that allows for the passage of a powdered, particulate, and/or granulated material from one side thereof through to the other side. In such a manner, the sieve does not specifically remove particulates, etc., from possible transfer therethrough, but allows for a metered distribution of such materials for the ability to thoroughly coat the target food product to the desired level. The sieving components should be manufactured from similar materials as noted above, although for cost purposes, plastic materials (such as high density polyethylene) are potentially preferred. The structure of the sieving component should permit even distribution of the powdered, etc., coating over the target substantially flat food product and thus may constitute a typical mesh construction of substantially even distance between openings therein. Alternatively, and potentially preferred, is a structure of plastic or metal with multiple holes present within the base structure exhibiting similar bore sizes and even distribution symmetrically throughout the entire sieving component itself. In this manner, as noted above, the even coating may be applied, although the number of holes closer to the center of the circularly shaped sieve component may be more concentrated than in outer regions of the structure itself. In any event, an even distribution in terms of symmetry is the primary aim in order to provide an ultimately substantial uniform distribution of powdered, etc., coating over the same general regions of the target substantially flat food product. Thus, although the center areas of the food product may have greater concentrations of flavoring/seasoning, in terms of distributions over the entire product surface, the concentration in the middle is compared with the other middle regions rather in comparison with the outer discrete regions of the product. Such a sieve component design is discussed in greater detail below, although the overall structure of the base component of the sieve should be configured to fit within the confines of the bowl portions of the overall device. In this manner, the sieve components should fit snugly within the bowl portions in order to prevent undesired transfer of particulate, granulate, powdered, etc., flavoring and/or seasoning around the peripheral edges of the sieve components during application of such materials to a subject flat food product present within the enclosed device. As such, the only transfer of such flavoring, etc., materials should occur through the openings of the sieve components to effectuate the desired uniform/metered coating of the subject food product.

The term “substantially flat food product” is intended to encompass any type of foodstuff that exhibits a substantially flat structure in order to properly fit within the area between the two sieving components of the inventive device when all the individual components are in place and the two circular portions are attached. Thus, any type of bread product, such as a cracker, a tortilla, tortilla shell, tortilla chip, pita, and the like, may be utilized as the substantially flat food product within this invention. Likewise, any team of other type of foodstuff, including meats (such as steaks, chicken, seafood, and the like), vegetables, and fruits, may fall within this definition as the important limitation of the device in this respect concerns the ability of the enclosed device to house and permit coating through flavoring, etc., materials passing through the sieve components onto the food product surface(s). Thus, as long as a proper amount of flavoring, etc., material is introduced within at least one of the two bowl portions (preferably both) and the sieve components are properly situated therein said bowl portions with the subject food product situated on one of the sieve components and the entirety of the two bowl portions included all of such materials, components, etc., can then be attached to create a fully enclosed device, then the device may be employed in such a manner. Although bread, tortilla, pita, etc., food products are preferred, and, in particularly flat products of this type are particularly preferred, in actuality, the overall term “flat food product” is thus intended to allow for any such food product that may be introduced and coated with the device in its fully enclosed configuration.

Preferably, for the purposes of allowing for proper seasoning of such foodstuffs associated with more exotic tastes and dishes, pitas and tortillas (of all types) are particularly preferred, as noted above. Such food products may be coated with a liquid mixture prior to flavor, etc., application, such as milk, water, cream, and the like, in order to effectuate greater adhesion of the flavoring/seasoning to the product surface, if desired. Likewise, no such prior coating may be necessary to allow for proper adhesion to the product surface. The coated product may be ingested thereafter without any further heatsetting or melting or other action prior to ingestion, if desired. Alternatively, the consumer may choose to apply the flavoring, etc., and place the food product in an appropriately heated oven or other heating vessel (such as a fryer) to allow for integration of the flavoring, etc., within the food product itself prior to ingestion.

The choice of flavoring or seasoning is unlimited and is left to the discriminating palate of the consumer. The amount, as well, is up to the consumer as the only limit in that respect is the amount that the actually bowl portions may hold without spilling over the lip thereof. Thus, any type of flavoring or seasoning, including, without limitation, pepper, salt, turmeric, cheese powder, onion powder, powdered sour cream flavoring, cinnamon, nutmeg, jalapeno spice, pepper, cinnamon, nutmeg, ginger, allspice, mace, cloves, pepper (e.g., cayenne, jalapeno, chipotle, chili), peppercorns, mustard, oregano, chives, anise, basil, black pepper, cilantro, salt, cheese, chili, garlic, Cajun spice, ranch, sour cream and onion, chili pepper powder, monosodium glutamate, sugar, artificial seasoning, butter flavors, cheese flavors (such as, for instance, whey) and the like (the list covers any available powdered, granulated, and/or particulate spice, seasoning, and/or flavoring, available to the culinary artist, in essence). Such a flavoring or seasoning may be present at any acceptable concentration within a powdered or slightly moistened formulation to effectuate the desired amount of seasoning and/or flavoring to one or both surfaces of the subject flat food product. The only possible limitation is the proper consistency of the flavoring and/or seasoning in terms of particulate, granulate, and/or powdered material size in order to permit proper passage through the sieving component opening, screen, mesh, etc., during utilization of the manually operated device. As noted above, a slightly moist flavoring/seasoning material may be possible, though generally frowned upon due to potential clogging of the sieve component openings. Such moistened materials, however, may adhere to the food product surface more easily than if completely dry, depending, again, upon the ability of the materials to properly pass through the sieve component openings without incident.

The seasoning/flavoring formulation may include other ingredients that do not accord tastes/flavors to the subject food product during use. For example, the powdered, etc., flavoring/seasoning formulation may have bulking agents, flow agents, binding agents, carrier agents, and preservatives, as examples. Bulking agents are additives used to increase the volume of a composition. This bulking agent may include, but is not limited to, whey, cellulose, dextrose, lactose, maltodextrin methylcellulose, xanthan gum, sugar alcohols (e.g., maltitol, sorbitol, mannitol, and xylitol) and polyvinylpyrrolidone. Flow agents help ingredients move smoothly from one location to another during manufacture. In addition, these agents act as anticaking agents reducing the hygroscopicity of the mixture and making the powder more resistant to exposure to humid environment. They may include, but are not limited to, precipitated silica, calcium stearate, glyceryl monostearate, and glyceryl triacetate, as examples. Binding agents are substances that makes a loose mixture stick together. They may include, but are not limited to, dextrose, starch, cellulose, dextrin and glycerin. Carrier agents are substances that aid the uniform distribution, mixing, and handling of other ingredients. They may include, but are not limited to, microcrystalline cellulose, citric acid, dextrose, fructose, magnesium carbonate, polyethylene glycol, polydextroses, polyoxyethylene sorbitan, polyvinylpyrrolidone, and precipitated silica. Preservatives prevent or inhibit spoilage of food due to fungi, bacteria and other microorganisms. They may include, but are not limited to, preservatives such as sodium benzoate, sorbic acid and its salts thereof, and lauric arginate. It should be noted that some of these extra ingredients within the seasoning/flavoring formulations useful with this inventive device may serve dual purposes.

### BRIEF DESCRIPTION OF THE DRAWINGS

FIG. 1 depicts an aerial view of a potentially preferred sieving component.

FIG. 2 depicts a side view of the same sieving component of FIG. 1.

FIG. 3 depicts an aerial view of the overall application device when completed attached.

FIG. 4 depicts an elevated side view of the same device as in FIG. 3.

FIG. 5 depicts a transparent side view of the same device as in FIG. 3.

FIG. 6 depicts a transparent side view of the same device as in FIG. 5, but from an angle 90° from that shown in FIG. 5.

### DETAILED DESCRIPTION OF THE DRAWINGS AND PREFERRED EMBODIMENTS

Specific features of the exercise apparatus of the present invention are detailed in the following Detailed Description of the Invention and the accompanying drawings. The preferred modes of the present invention are also described therein. Those having ordinary skill in the exercise device arts will recognize alternative means of accomplishing the objects of the present invention, all of which are deemed to be equivalent to and to fall within the scope of the present invention.

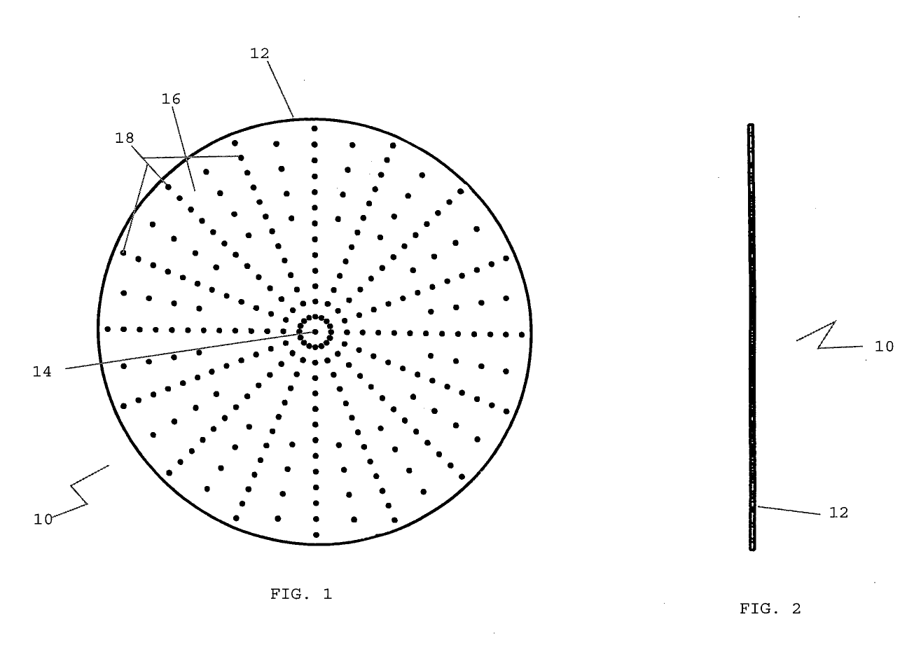

FIG. 1 provides one potentially preferred embodiment of a sieving component 10. Such a component 10 may be present as both of the sieving components present within the overall device (120 in FIG. 3, for instance), or one sieving component 10 may be of this configuration with the other in a different configuration (such as a wire mesh, as one example). For efficiency in manufacture, it is potentially preferred to have the same type of sieving component for both components within the overall device, however. Thus, the sieving component 10 exhibits an outer periphery 12 thus depicting a proper potentially preferred circular shape and a middle point 14 from which the design of the sieve openings radiates. The base material 16 is preferably, as noted above, high density polypropylene, as one potentially preferred example, and multiple openings 18 are present in symmetrical form throughout the entire component 10. FIG. 2 shows the general depth of the overall component disk 10 with the outer periphery 12 providing, again, the circular shape. The diameter of such a component 10 is roughly similar to that of the circular portions of the overall device (120 in FIG. 3), but a slightly lower measurement to permit introduction and level nesting within the hollow areas of the device upon full attachment of all components.

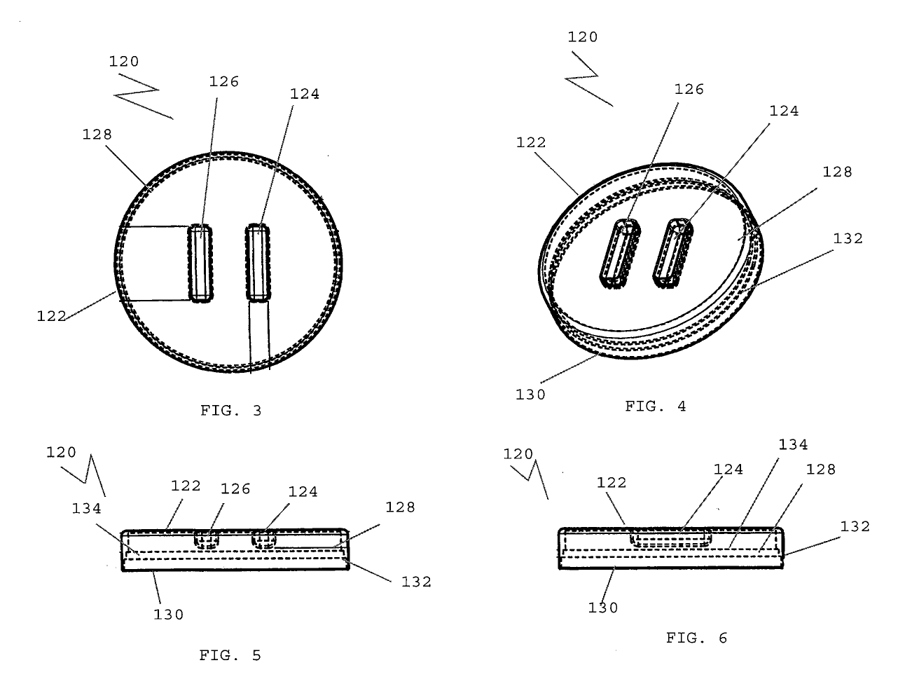

FIG. 3 thus shows the entire device 120 with all of the components attached and in place. Thus the greater diameter circular bowl portion 122 is attached in overlapping relation to the lower diameter circular bowl portion 130 (FIG. 4). Indentations 124, 126 are present to permit grip of the device 120 during use as well as placement at least one of the sieving components 128. FIG. 4 provides a broader view fully attached device with the greater diameter circular bowl portion 122 and the complementary sieving component 128 attached to the lower diameter circular bosl portion 130 and its own sieving component 132. The indentations 124, 126 are also present. FIGS. 5 and 6 provide a better view of the hollow portions and the area in which the flat food product 134 is created by the properly distanced sieving components 128, 132 after the two circular bowl portions 122, 130 are attached to form the entire device 120. Thus, the hollow portions above and below the two sieving components 128, 132 may be filled with as much powdered, particulated, and/or granulated flavoring and/or seasoning as desired. Upon attachment of the two circular portions 122, 130 with the sieving components 128, 132 in place, the hollow portions including such flavoring, etc., and the flat food product area 134 filled in such a manner, the consumer may shake, roll, basically maneuver the overall device 120 as needed to apply the desired level of flavoring, etc., to the food product through the sieving components 128, 132, as described above.

Such a device, being completely enclosed, thus permits individualized coating of targeted tortillas and/or other substantially flat food products to allow for a consumer to flavor and/or season such a product as desired (if the size of the desired food product allows for such, multiple food products may be placed within the device for coating of such multiple products simultaneously). In such a manner, the consumer may avoid purchases in bulk amounts of uniformly flavored flat food products and give greater versatility and capability to the user to meet their own taste needs and desires in food preparation.

While the preferred embodiment and best mode of the present invention have been described herein in order to illustrate the principles and applications thereof, it is understood that various modifications or alterations may be made to the present invention without departing from the true scope of the invention set forth in the appended claims.

What is claimed is:

1. A manually operated device for the application of a powdered or granulated substance to a flat food product, said device including at least two substantially similarly shaped bowl portions, both including locking means for attachment of each bowl portion to the other in detachable fashion, and two sieve components shaped to fit within said at least two substantially similarly shaped bowl portions such that upon attachment of said bowl portions and inclusion and attachment of said sieve components within said bowl portions, each resultant bowl portion exhibits a hollow region for the presence of a powdered or granulated substance, wherein said bowl portions and said sieve components, when attached together, form an integrated, yet detachable, enclosure, and wherein said sieve portions are positioned internally within said connected bowl portions to allow for the placement of said flat food product between said sieve components such that said powdered or granulated substance may pass through said sieve components to contact at least a portion of said flat food product.

2. The application device of claim 1 wherein said similarly shaped bowl portions are both substantially circular in shape.

3. The device of claim 1 wherein said sieve components are selected from the group consisting of metal mesh materials, wire mesh materials, plastic materials having multiple holes present therein, metal materials having multiple holes present therein, and any combination thereof.

4. The device of claim 1 wherein either or both of said substantially similarly shaped bowl portions includes closable access means for the introduction of said powdered or granulated substance into the hollow regions of said sieve component-containing circular portions.

5. The device of claim 1 wherein said flat food product is a tortilla.

6. The device of claim 2 wherein said flat food product is a tortilla.

7. The device of claim 3 wherein said sieve components are plastic materials having multiple holes present therein.

8. The device of claim 3 wherein said flat food product is a tortilla.

9. The device of claim 4 wherein said flat food product is a tortilla.

10. The device of claim 7 wherein said flat food product is a tortilla.

11. A method of applying a powdered or granulated substance to at least one flat food product, said method comprising:
a) lying the device as described in claim 1, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

12. A method of applying a powdered or granulated substance to at least one flat food product, said method comprising:
a) supplying the device as described in claim 2, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

13. A method of applying a powdered or granulated substance to at least one flat food product, said method comprising:
a) supplying the device as described in claim 3, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

14. A method of applying a powdered or granulated substance to at least one flat food product, said method comprising:
a) supplying the device as described in claim 4, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

15. A method of applying a powdered or granulated substance to at least one flat food product, said method comprising:
a) supplying the device as described in claim 5, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

16. A method of applying a powdered or granulated substance to at least one flat food product, said method comprising:
a) supplying the device as described in claim 6, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

17. A method of applying a powdered or granulated substance to at least one flat food product, said method comprising:
a) supplying the device as described in claim 7, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

18. A method of applying a powdered or granulated substance to at least one flat food product, said method comprising:
a) supplying the device as described in claim 8, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

19. A method of applying a powdered or granulated substance to at least one flat food product, said method comprising:
a) supplying the device as described in claim 9, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.

20. A method of applying a powdered or granulated substance to at least one flat food product, said method comprising:
a) supplying the device as described in claim 10, wherein said bowl portions have not been attached to one another;
b) introducing an amount of powdered, granulated, and/or particulate material selected from the group consisting of at least one flavoring formulation, at least one seasoning formulation, and any mixtures thereof, within the bowl portions of said device of step “a,” wherein said amount of said material is at most up to the lip of each of said bowl portions;
c) placing said sieve components over said materials in nesting fashion within each of said bowl portions;
d) placing said at least one flat food product onto the surface of one of said sieve components such that said food product is parallel to said sieve component surface;
e) attaching said bowl portions together through said locking mechanism to form the fully enclosed device; and
f) manually moving said fully enclosed device to permit movement of said materials through said sieve components to contact the surface of said at least one flat food product.
